(19) United States
(12) Patent Application Publication
(10) Pub. No.: US 2008/0017784 A1
(43) Pub. Date: Jan. 24, 2008

(54) Apparatus and methods to locate and track the sun

(76) Inventors: John E. Hoot, San Clemente, CA (US); Kenneth W. Baun, Trabuco Canyon, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/490,786

(22) Filed: Jul. 21, 2006

(51) Int. Cl. G01J 1/20; G01C 21/24; G01C 21/02

(52) U.S. Cl. 250/203.4

(57) ABSTRACT

Apparatus and methods are disclosed that enable a device to locate and track a light source. In certain preferred embodiments, the device is a telescope and the light source is the sun. In some embodiments, the apparatus includes a plurality of photodetectors and a plurality of shade casting members. The shade casting members may be disposed substantially symmetrically about an optical axis of the apparatus. In certain embodiments, the apparatus can locate and track the light source by comparing one or more signals produced by the photodetectors in response to light received from the light source.

### BACKGROUND

1. Field of the Invention

This application relates to apparatus and methods for locating and tracking light from an object such as, for example, the sun.

2. Description of the Related Art

Solar astronomy, which is the science related to the nature of the sun, has become increasingly popular in the past decade. Solar observations can reveal sunspots, solar storms, prominences, flares, plage, filaments, and granulation, all of which change from day-to-day or even hour-to-hour. By tracking the progress of sunspots across the face of the sun, an individual can determine the rotation period of the sun, just as Galileo Galilei did in the 1600s.

Recent advances in high performance solar telescope design and construction enable individuals to observe solar features with greater ease than ever before. However, observing the sun can be dangerous if not performed properly, because the sun's intense radiation can permanently damage an observer's eyes. Accordingly, solar telescopes are commonly provided with filters to block a high percentage of the sun's light and/or devices to project the sun's light safely onto a viewing screen. However, to undertake solar observations, a solar telescope is generally pointed toward the sun and then is moved to track the motion of the sun across the sky. During both of these procedures, there is a potential for serious eye damage.

Amateur solar astronomers have used simple methods and devices to locate and track the sun. For example, to coarsely point the telescope at the sun, an observer may manually move the telescope until its shadow has a minimum area on the ground. To provide finer scale pointing, an observer may mount a secondary tube to a telescope tube, the secondary tube having a pinhole aperture at one end that projects an image of the sun onto a translucent screen at an opposite end. The screen may have a crosshair reticle to assist pointing. The foregoing methods and devices advantageously assist in pointing a telescope toward the sun.

In other technological disciplines, optoelectronic devices have been used to automate the location and tracking of light sources. For example, earth-orbiting satellites may use a photodetector to enable the satellite to be oriented with respect to the sun. Photovoltaic generating systems may also use a light sensor to orient solar panels or solar cells so as to maximize their absorbance of solar radiation. In still other disciplines, visible and infrared light sensors may be used to detect laser beams commonly used to align industrial machinery and to detect displacement and vibration of target objects. These light sensors typically comprise one or more position-sensing detectors (PSD's) that detect and measure the position of an incident light beam.

However, many such light detectors suffer from disadvantages such as limited measurement range and high cost and complexity. Additionally, many such detectors are not designed to work under bright, daylight conditions such as those occurring during telescopic observation of the sun. Accordingly, there is a need for improved apparatus and methods for locating and tracking the sun.

### SUMMARY

An embodiment of a sunfinder capable of providing an electronic indication of sun location comprises a plurality of photodetectors. Each photodetector is capable of determining at least a presence of illumination. The sunfinder further comprises a plurality of light reduction members and a processing device. The processing device is responsive to the plurality of photodetectors to determine at least an indication of a direction of sun location relative to a field of view of the sunfinder.

An embodiment of a method of automatically directing a device toward a light source comprises receiving light from a light source on at least one surface. The at least one surface comprises a plurality of shadow casting elements. The light is incident on the at least one surface at an angle. The method further comprises automatically determining a direction of movement of the surface that changes the angle in a manner that moves a device closer to a desired orientation with respect to a location of the light source.

An embodiment of a light source locator adapted to electronically determine a position of a light source relative to a position of the locator is disclosed. The light source locator comprises a plurality of light altering elements and at least three light sensing elements responsive to light altered by one or more of the plurality of light altering elements.

An embodiment of a light source locator adapted to electronically determine a position of a light source relative to a position of the locator is disclosed. The light source locator comprises one or more light altering elements and one or more light sensing elements. The light sensing elements are responsive to light altered by one or more of the light altering elements. In an embodiment, the light source locator comprises one light altering element.

An embodiment of a sunfinder capable of providing an electronic indication of sun location comprises one or more photodetectors. Each photodetector is capable of determining at least a presence of illumination. The sunfinder further comprises one or more light reduction members. The sunfinder includes a processing device that is responsive to at least one of the photodetectors to determine at least an indication of a direction of sun location relative to a field of view of the sunfinder. In an embodiment, the sunfinder comprises one light reduction member.

Certain embodiments are summarized above. However, despite the foregoing summary of certain embodiments, only the appended claims (and not the present summary) are intended to define the invention(s). The summarized embodiments, and other alternate embodiments and/or uses and obvious modifications and equivalents thereof, will become readily apparent from the following detailed description of certain preferred embodiments having reference to the attached figures. The invention(s) disclosed herein are not limited to any particular embodiment(s) discussed.

### BRIEF DESCRIPTION OF THE DRAWINGS

FIG. 1 is a perspective view of an embodiment of a light source locator for locating and tracking light from an object, which comprises a plurality of light reducing members and a plurality of photodetectors.

FIG. 2 is a plan view of the light source locator shown in FIG. 1.

FIG. 3 is a top view of the light source locator taken along the line 3-3 in FIG. 2.

FIG. 4A is a top view of another embodiment of the light source locator which comprises additional photodetectors.

FIG. 4B is a top view of another embodiment of the light source locator in which the light reducing members are not oriented at right angles and in which the photodetectors have different sizes.

FIGS. 5A-5D are top views of embodiments of light source locators comprising a plurality of photodetectors and one (FIG. 5A), two (FIG. 5B), three (FIG. 5C), and six light reducing members (FIG. 5D).

FIG. 6 is a perspective view of an embodiment of a light source locator comprising a housing that protects and shields the photodetectors and modifies the light source locator's field of view.

FIG. 7 is a schematic diagram illustrating the light source locator's pointing accuracy in relation to the position and size of the photodetectors and the length of a light reducing member.

FIG. 8A is a top view of an embodiment of a light source locator that comprises a quadrant detector configured to provide fine scale location and tracking of the object.

FIG. 8B is a top view of another embodiment of a light source locator providing fine scale location and tracking wherein the quadrant detector is disposed within a tube having a pinhole imaging aperture or a lens on an end facing the object.

FIG. 9 is a schematic diagram of an embodiment of a light source locator mounted to a telescope.

FIG. 10 is a flowchart illustrating an embodiment of a method that can be used by the system shown in FIG. 9 to locate and track the sun.

FIG. 11A is a schematic diagram of an arrangement of photodetectors in a light source locator mounted on an altitude-azimuth telescope (not shown). The photodetectors produce signals A, B, C, and D in response to light received from an object.

FIG. 11B is a flowchart illustrating an embodiment of a process for locating and tracking a light source.

### DETAILED DESCRIPTION OF CERTAIN PREFERRED EMBODIMENTS

Embodiments of the present disclosure include device(s) capable of electronically determining an orientation of a housing with respect to a light source, and capable of outputting signals usable to reposition the housing. For example, in an embodiment, a sunfinder includes a plurality of light sensitive devices and at least one light altering device, where the light sensitive devices output one or more signals usable to reposition a telescope toward a light source such as the sun. In additional embodiments, a light source locator comprises one or more light reducing members that are disposed around an optical axis of the light source locator. The light reducing members may comprise fins or vanes having portions that are substantially opaque to the light from an object to be located. One or more photodetectors, which are responsive to light received from the object, are disposed proximate the light reducing members. The photodetectors produce one or more signals indicative of a presence or an amount of light received by the photodetectors. In an embodiment, the object is located away from the optical axis of the light source locator, the light reducing members cast shadows across some or all of the photodetectors. Accordingly, the photodetectors produce signals of different values. In an embodiment, processing circuitry compares the values of the signals and determines a direction of the object relative to the optical axis of the locator. The processing circuitry may transmit one or more signals indicative of the object's direction to other devices, such as drive motors, which can be used to reposition the light source locator so that it points more closely toward the object. In some embodiments, the light source locator is coupled to another device, such as a telescope, and is used to point the device towards the object.

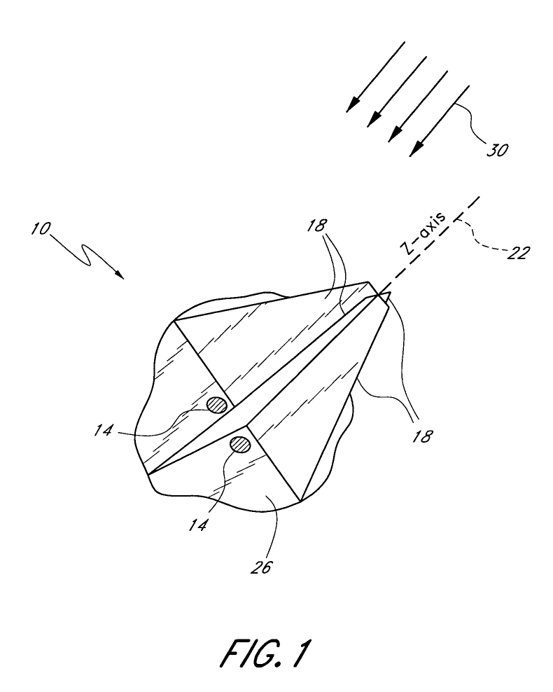

FIG. 1 is a perspective view of an embodiment of a light source locator 10 for locating and tracking light from an object. The light source locator 10 comprises a plurality of photodetectors 14 and a plurality of light reducing members 18. The photodetectors 14 and the light reducing members 18 are disposed around an optical axis 22 centrally located through the light source locator 10. The light source locator 10 has proximal and distal ends. In the embodiment shown in FIG. 1, the photodetectors 14 are disposed on a base 26 at the proximal end of the light source locator 10. The light reducing elements 18 are disposed substantially perpendicularly to the base 26 and substantially perpendicularly to the optical axis 22. The distal end of the light source locator 10 may be pointed toward the object.

In some embodiments, the light reducing members 18 comprise thin, elongated elements that project substantially perpendicularly away from the optical axis 22. Each of the light reducing members 18 may comprise a structure such as, for example, a fin or a vane. In some embodiments, each of the light reducing members 18 has substantially similar shape and size. The light reducing members 18 are arranged about the optical axis 22 such that a region is defined between successive light reducing members 18. In some embodiments, the light reducing members 18 are spaced substantially symmetrically about the axis 22 so that the regions have substantially similar size and shape. In the embodiment shown in FIG. 1, the light reducing members 18 comprise substantially similarly shaped fins that are disposed about the optical axis 22 with each fin being substantially perpendicular to a preceding or subsequent fin. Accordingly, each successive pair of fins defines a region that is a quadrant comprising about ninety degrees. In other embodiments, a different number of light reducing members 18 may be used, such as, for example, one, two, three, four, five, six, or more members using similar or different positioning. In some embodiments, the light reducing members 18 may be attached to the base 26 and also may be attached to each other along a portion of the optical axis 22. The light reducing members 18 may be attached by any means including, for example, welds, adhesives, rivets, screws, etc.

The light source locator 10 can be fabricated using various methods well-known in the art. For example, the light source locator 10 may be assembled from one or more pieces that are milled, punched, or cut from a material, such as a metal. Some of the pieces may be bent so as to form parts of the detector 10. For example, a piece of metal may be bent at a right angle to form a pair of the light reducing members 18 shown in FIG. 1. In some embodiments, the light reducing members 18 can be fabricated from separate pieces that are interlocked via one or more corresponding grooves. In other embodiments, the light source locator 10 or its components can be formed by machining, extruding, molding, casting, or other manufacturing techniques. Many variations are possible.

In certain embodiments, the light reducing members 18 are substantially opaque to the light from the object. The light reducing members 18 may comprise metal, plastic, or other suitable material. In certain preferred embodiments, the light reducing members 18 are substantially rigid so that they do not deform, flex, or alter their mutual orientation as the light source locator 10 is moved. For example, the light reducing members 18 may comprise aluminum, titanium, brass, or steel. In other embodiments, the light reducing members 18 comprise polymeric compounds. The light reducing members 18 may have surfaces prepared to reduce light reflections and ghosts. For example, in some embodiments, the surfaces of the light reducing members 18 have a matte black color produced by painting or anodizing. In other embodiments, the light reducing members may comprise a material that is partially transparent or translucent and may comprise material, such as a filter, that transmits only a portion of the electromagnetic spectrum.

In the embodiment shown in FIG. 1, a single photodetector 14 is disposed in each region defined between successive light reducing members 18. In other embodiments, more than one photodetector may be disposed within each region. Each photodetector 14 may comprise one or more optoelectronic devices, which produce one or more signals in response to light power incident on the optoelectronic devices. A photodetector 14 may comprise a photodiode, an avalanche photodiode, a phototransistor, a photoresistor, a photomultiplier, a quadrant detector, a lateral-effect detector, a charge coupled device (CCD), or other such light sensing device. The signal produced by a photodetector 14 may comprise an electrical signal such as, for example, a voltage, a current, or a change in electrical resistance. In certain preferred embodiments, each photodetector 14 comprises a semiconductor photodiode configured to operate in a reverse-biased photoconductive mode. In these embodiments, the signal from each photodetector 14 comprises a photocurrent that is in a substantially linear relationship to the incident light power over a wide range of incident light powers. In certain embodiments, each of the photodetectors 14 is substantially similar in size, shape, and operating characteristics. However, in other embodiments, the photodetectors 14 may have different properties including, for example, spectral sensitivity, light sensitive area, shape, size, electrical characteristics, etc.

The light from the object may comprise one or more portions of the electromagnetic spectrum such as, for example, ultraviolet, visible, infrared, microwave, radio, or other portions. In various preferred embodiments, the photodetectors 14 are responsive to visible light received from the object. In other embodiments, the photodetectors 14 are responsive to light having wavelengths in the range from about 400 nm to about 1100 nm.

As shown in FIG. 1, the photodetectors 14 are disposed on the base 26. The base 26 may comprise a substantially rigid material that resists deformation or flexion as the light source locator 10 is moved. The base 26 may be substantially opaque to the light from the object. For example, the base 26 may comprise a metal or a plastic. In certain embodiments, the base 26 comprises aluminum, titanium, brass, or steel. In other embodiments, the base 26 comprises various polymeric compounds. It is preferred, although not necessary, that the base 26 be oriented so that a light sensing surface of each of the photodetectors 14 is substantially perpendicular to the optical axis 22. Although in certain preferred embodiments the optical axis 22 is perpendicular to the base 26, in other embodiments the base 26 and the light reducing members 18 are disposed so that the optical axis 22 and the base 26 form an angle that is not substantially equal to ninety degrees. In an embodiment, the base 26 comprises a rectangular or square shape, while in other embodiments, the base 26 comprises a circular, oval, or some other shape. The shape of the base 26 may be governed by the mechanism for affixing the locator 10 on a device such as, for example, a telescope. The base 26 (or other portions of the locator 10) may include additional features, structures, or components such as, for example, mounting devices, alignment devices and/or housings (e.g., for electronics).

Electrical connections from the photodetectors 14 may be passed through one or more holes or openings in the base 26 so that the photodetectors 14 may transmit their signals to additional electrical processing components as described herein. In other embodiments, a base 26 is not included in the light source locator 10. In such embodiments, the photodetectors 14 may be disposed adjacent to the light reducing members 18, for example, on a flange, a lip, or an edge protruding away from the light reducing members 18.

As shown in FIG. 1, rays of light 30 from the object are received by the light source locator 10. The object may be a terrestrial or a celestial object or target. In certain embodiments, the object is the sun or the moon. If the light source locator 10 is oriented so that the optical axis 22 points substantially toward the object, the light rays 30 will be incident substantially normally on each of the photodetectors 14. Each of the photodetectors 14 will receive substantially the same incident light power, and each will produce signals that are substantially equal in value. Accordingly, by comparing the signals a user may determine that the light source locator 10 is pointed substantially toward the object.

In contrast, when the optical axis 22 of the light source locator 10 is pointed away from the object, the light rays 30 will be received from an off-axis direction. Portions of the light rays 30 will be blocked by the light reducing members 18, which cast shadows across the base 26. Some photodetectors 14 will receive more (or less) light than other photodetectors 14, and for some off-axis directions, some of the photodetectors 14 will lie entirely within a shadow. Accordingly, for off-axis objects, the photodetectors 18 will produce signals that are generally unequal in value. By comparing these signals, a user may determine the off-axis direction of the object as discussed further herein. Therefore, the light source locator 10 can be used to determine the location (e.g., a direction) of the light emitting object with respect to the optical axis 22.

As shown in FIG. 1, the optical axis 22 of the light source locator 10 may be designated as the z-axis and has orthogonal x- and y-axes. In some embodiments, the off-axis direction of the object may be characterized, for example, by spherical polar coordinates or by Cartesian (x,y,z,) coordinates. The spherical polar coordinates may include a polar angle measured relative to the z-axis and an azimuthal angle in the x-y plane measured relative to the x-axis.

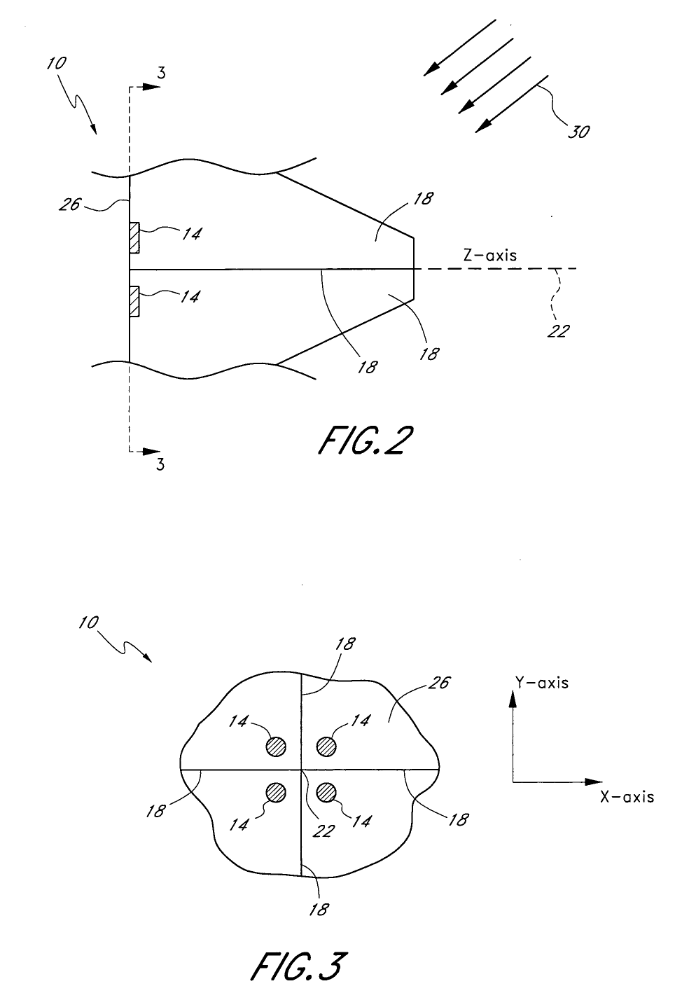

FIG. 2 is a plan view of the light source locator 10 shown in FIG. 1. This embodiment of the light source locator 10 comprises four light reducing members 18 having substantially similar shape and size. The light reducing members 18 are oriented substantially perpendicular to the base 26 and substantially perpendicular to the optical axis 22. Successive light reducing members 18 define a region therebetween, which is a quadrant comprising about ninety degrees in this embodiment. One photodetector 14 is disposed within each quadrant of the light source locator 10. Each light reducing member 18 may advantageously by shaped to ensure suitable shadowing. However, a skilled artisan will recognize from the discussion herein that a wide variety of shapes and/or sizes may be utilized. For example, each light reducing member 18 may advantageously include a trapezoidal cross-sectional shape. Other cross-sectional shapes are possible. For example, in other embodiments, the shape may comprise a triangle, square, rectangle, or a portion of a circle or oval. In the embodiment shown in FIG. 2, the light reducing members 18 are substantially thin and flat, although this is not a requirement. For example, in some embodiments, the light reducing members 18 comprise beams, blocks, wedges, wires, rods, plates, posts, and/or bars having substantial thickness. In other embodiments, the light reducing members 18 may be curved. The light reducing members 18 have dimensions (e.g., a length and a width) that can be selected to provide accurate object location and tracking as discussed further herein.

Portions of the light reducing members 18 may be substantially opaque to light from the object so as to cast suitable shadows on, for example, the photodetectors 14. In certain embodiments, the light reducing members 18 include apertures, holes, windows, notches, and the like to provide suitable shadowing. In some embodiments, the light reducing members 18, or other appropriate portions of the light source locator 10, comprise filters, polarizers, lenses, mirrors, pinholes, beamsplitters, optical fibers, or other optical elements.

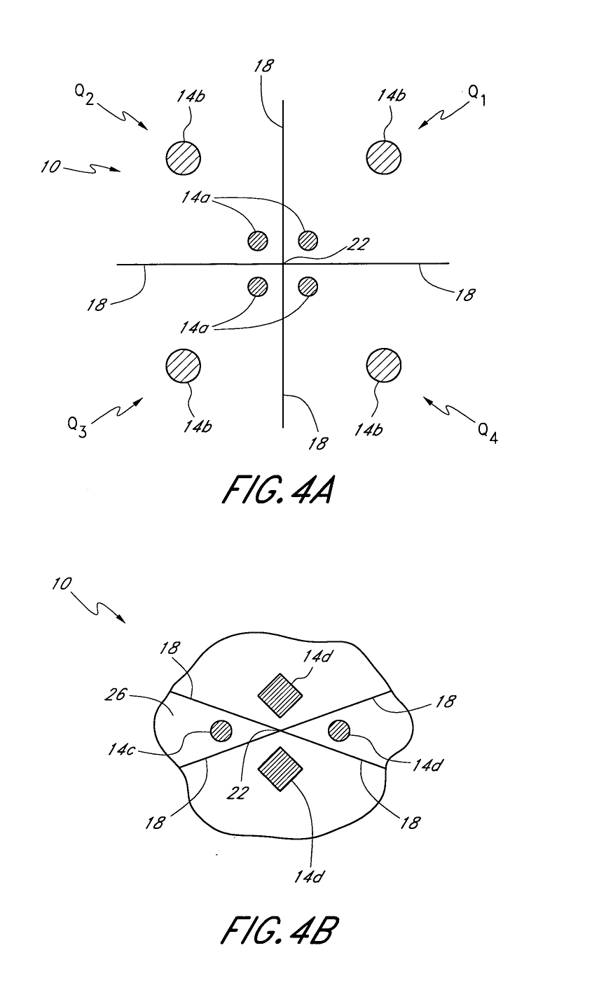

FIG. 3 is a top view of the light source locator 10 taken along the line 3-3 in FIG. 2. Each of the photodetectors 14 is disposed within a quadrant defined between adjacent light reducing members 18. It is preferable, although not necessary, for the photodetectors to be disposed relatively close to the optical axis 22 so as to enable location of the object with increased accuracy as discussed further herein. Although four photodetectors 14 are shown in FIG. 3, this is not a requirement, and in some embodiments fewer or more photodetectors 14 may be used. For example, in some embodiments, each of the quadrants may include two or more photodetectors in order to enable more accurate or more precise location measurements.

In an embodiment, the base 26 has a cross-sectional shape that is substantially square. In other embodiments, the base 26 may have a shape that is non-square, such as a rectangle, a triangle, or a circle. Many shapes are possible. In certain embodiments, the light source locator 10 does not include a base 26, and the photodetectors 14 are disposed on flanges, rims, or edges projecting from the light reducing members 18. In the embodiment shown in FIG. 3, the light reducing members 18 are arranged symmetrically around the optical axis 22 so that successive light reducing members 18 are separated by about ninety degrees. In other embodiments, the light reducing members 18 are arranged so that successive members 18 subtend different angles. FIG. 3 also depicts the x- and y-axes that are orthogonal to the optical axis 22 (the z-axis).

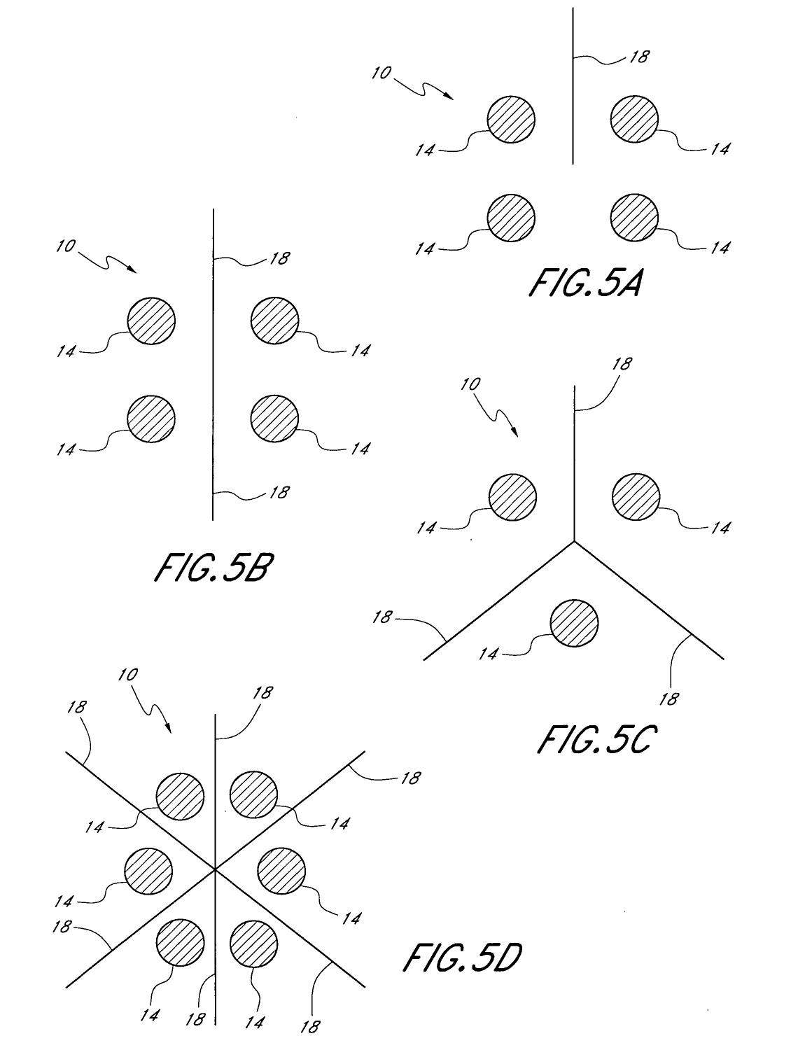

FIGS. 4A and 4B illustrate different embodiments of a light source locator 10 comprising four light reducing members 18. In the embodiment shown in FIG. 4A, two photodetectors 14a and 14b are disposed within each of the four quadrants: Q1, Q2, Q3, and Q4. In each quadrant, the photodetectors 14a are disposed closer to the optical axis 22 than the photodetectors 14b. Additionally, in some embodiments, the photodetectors 14a and 14b may have different sizes, shapes, or sensing characteristics. Embodiments of the light source locator 10 using more than one photodetector per quadrant may have advantages such as increased accuracy, resolution, and precision. For example, an off-axis light emitting object will cast a shadow in which different regions of the base 26 are in relative light or relative darkness. As an illustrative example, a light emitting object located in a direction toward the quadrant Q1 will cause the light reducing members 18 to cast shadows onto the quadrant Q3. Depending on the object's off-axis angle, the photodetector 14a in the quadrant Q3 may be in a relatively dark shadow, while the photodetector 14b in the quadrant Q3 may be in relatively bright illumination. The photodetectors 14a, 14b in quadrant Q3 will output signals having different values, which may be compared to provide information regarding the off-axis direction of the object. Certain embodiments of the light source locator 10 may utilize, for example, four, eight, twelve, sixteen, or more photodetectors. In other embodiments where less resolution is required, the light source locator 10 may utilize, for example, one, two, or three photodetectors.

FIG. 4B illustrates an embodiment of the light source locator 10 in which photodetectors 14c are different from photodetectors 14d. For example, the photodetectors 14d have larger light collecting surfaces and are shaped differently from the photodetectors 14c. In certain embodiments, some of the photodetectors 14c, 14d comprise photodiodes with a single sensing surface while others comprise a plurality of sensing surfaces. For example, in one embodiment, the photodetectors 14c are single photodiodes whereas the photodetectors 14d are quadrant detectors.

FIG. 4B additionally illustrates an embodiment in which the base 26 is rectangular rather than square, and in which the light reducing members 18 subtend angles that are substantially different from ninety degrees. Embodiments such as that depicted in FIG. 4B may be advantageous where higher accuracy, resolution, and precision are needed in one direction (e.g., the x-axis) as compared to another direction (e.g., the y-axis).

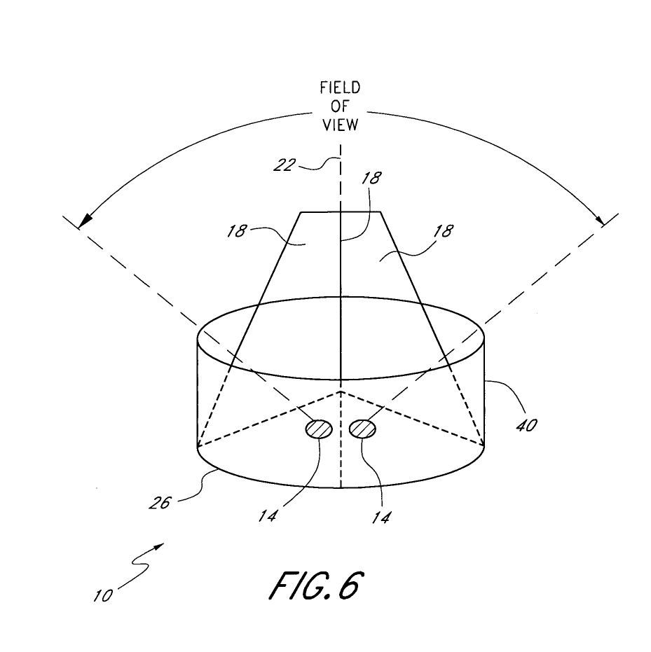

FIGS. 5A-5D illustrate top views of embodiments of the light source locator 10 that comprise different numbers of light reducing members 18 and different numbers of photodetectors 14. The exemplary base 26 in these embodiments has a generally circular cross-sectional shape, although any shape is acceptable. These embodiments comprise one (FIG. 5A), two (FIG. 5B), three (FIG. 5C), and six (FIG. 5D) light reducing members 18. In FIGS. 5B-5D, the light reducing members are disposed substantially symmetrically on their respective bases 26, although this is not a requirement. Other embodiments of the light source locator 10 may have different numbers, arrangements, orientations, and configurations of light reducing members 18 and photodetectors 14.

The example light source locator 10 illustrated in FIG. 5A comprises a single light reducing member 18. In such an embodiment, multiple photodetectors 14 can be used to sense the position of a shadow cast by the light reducing member 18. Four photodetectors 14 are shown in FIG. 5A, however, more could be used to provide higher accuracy location measurements. FIG. 5B illustrates a light source locator 10 having two light reducing members 18. Such embodiments are advantageously used in situations where the location of the object in only one direction is needed. FIGS. 5C and 5D illustrate embodiments of light source locators 10 with three and six light reducing members 18, respectively. Embodiments with a larger number of light reducing members 18 advantageously provide increased accuracy and precision for measurements of the direction to the object. Additionally, embodiments with a larger number of photodetectors 14 provide redundancy in the case of failure of one or more of the photodetectors 14.

Although disclosed with reference to one, two, three, four, and six light reducing members 18, a skilled artisan will recognize from the disclosure herein a whole range of shapes and structures that provide for electronic determination of the direction of radiation. For example, the light source locator may comprise a covering having apertures that can be used to shadow, mask, and/or direct light to photodetectors in a manner that provides an electronic determination of a direction of radiation. Portions of one or more coverings (or portions of one or more light reducing members in suitable embodiments) may filter or otherwise modify the characteristics of the light so as to enable the electronic determination of a light source direction or position. For example, in certain embodiments, a portion of the light source locator 10 comprises one or more graduated neutral density filters that provide a suitable light contrast to one or more electronic light detectors so as to provide a direction to the light source. In other embodiments, other types of filters or optical elements may be used. A skilled artisan will recognize that many variations are possible without departing from the scope of the principles disclosed herein.

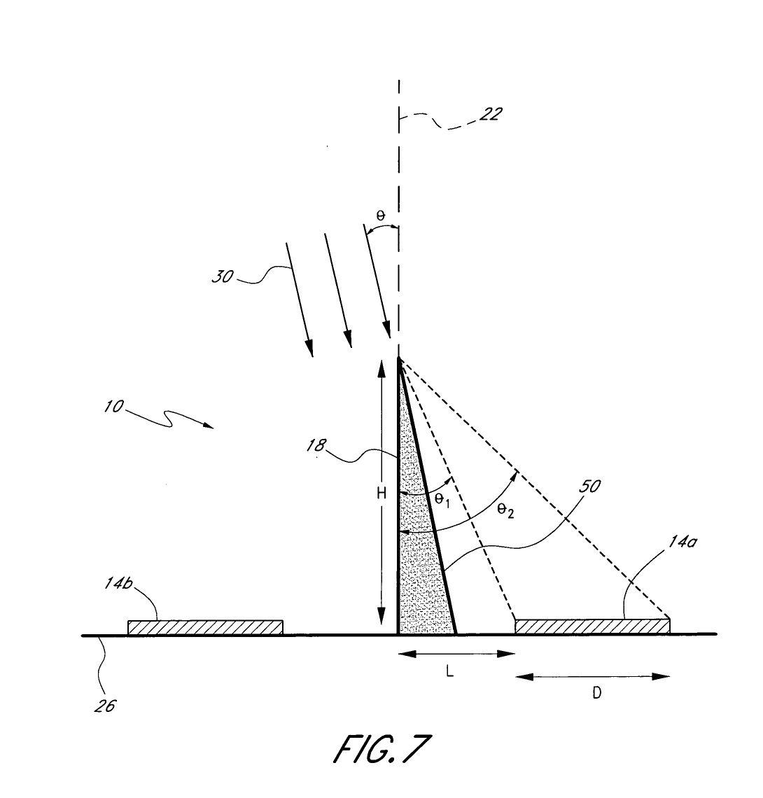

FIG. 6 is a perspective view of an embodiment of a light source locator 10 comprising a housing 40 that extends along a portion of the optical axis 22. A central axis of the housing 40 is substantially parallel to the optical axis 22. In this embodiment, the housing 40 extends from the base 26 of the light source locator 10 to a position part way toward the distal end of the light source locator 10, and comprises a hollow tube having a generally circular cross-sectional shape. In an embodiment, the housing 40 substantially surrounds the photodetectors 14 and extends along a portion of the light reducing members 18. In some embodiments, portions of the housing 40 are substantially opaque to the light from the object. The housing 40 provides several advantages such as, for example, protecting the photodetectors 14 from damage caused by contact with foreign substances and shielding the photodetectors 14 from ambient light not coming from the direction of the object. The housing 40 may extend a fraction of the length of the light reducing members 18 (as shown in FIG. 6), or the housing 40 may extend the entire length (or more) of the light reducing members 18. The housing 40 may comprise a sufficiently rigid material such as, for example, a metal or a plastic. The metal may comprise, for example, aluminum, titanium, brass, or steel or it may comprise various polymeric compounds. In certain embodiments, one or more baffles are disposed on an interior surface of the housing 40 to block stray light and to reduce internal reflections and ghosts. The baffles may comprise, for example, rings, ledges, edges, stops, or threads disposed within the housing 40. Additionally, the interior surface of the housing 40 may have a matte black finish to reduce internal reflections. In certain embodiments, the housing 40 comprises apertures, windows, or the like, and may include one or more optical elements such as, for example, mirrors, lenses, filters, and polarizers. The housing 40 may include a cover proximate to an end thereof. The cover may include apertures, lenses, mirrors, pinholes, and the like that are suitably configured to shadow, mask, or otherwise direct light into the locator 10.

The light source locator 10 has a field of view (FOV), which is an angle over which light from the object can be received by one or more of the photodetectors 14. In embodiments in which the housing 40 is substantially opaque to the light, the field of view will depend on the length of the housing 40. As can be seen from FIG. 6, the field of view will be smaller for longer housings. In embodiments without a housing 40, the field of view of the light source locator 10 approaches 180 degrees. In embodiments in which the object is the sun, the length of the housing 40 may be selected to provide a sufficiently large field of view (e.g., about 120 degrees), while still protecting the photodetectors 14 from damage and shielding them from stray, ambient light.

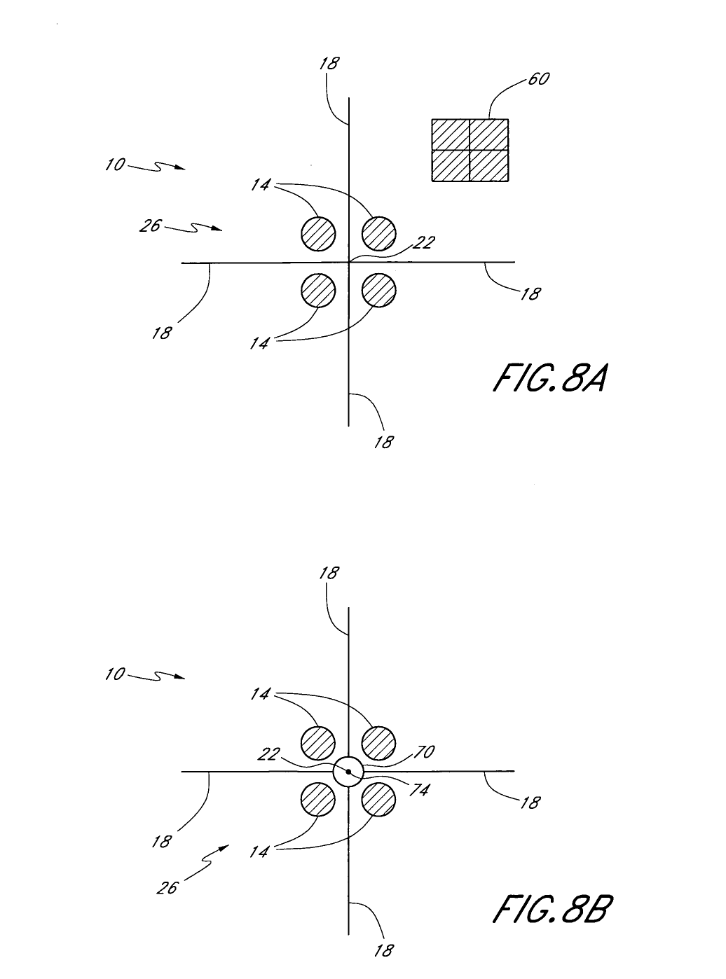

Further aspects relating to the angular pointing accuracy of a light source detector 10 are depicted in FIG. 7. For illustrative purposes, the light source locator 10 comprises two photodetectors 14a and 14b and a single light reducing member 18. The light reducing member 18 has a length H and is disposed along the optical axis 22 and perpendicular to the base 26. Each photodetector 14a, 14b has an inner edge that is located a distance L from the optical axis 22, and each has a light receptive area with a size D. The photodetectors 14a and 14b are substantially similar in size and shape and produce substantially similar signals when illuminated by light with substantially the same power.

Collimated light rays 30 from an object (which is assumed to be a distant point source of radiation) are incident on the light source locator 10 shown in FIG. 7. The light rays 30 are from an off-axis object and come from an off-axis angle θ measured with respect to the optical axis 22 of the light source locator 10. Light rays 30 that are nearly parallel to the optical axis 22 (e.g., having off-axis angles θ□1) will illuminate both of the photodetectors 14a and 14b, which will produce substantially equal signals. As the off-axis angle θ increases as shown in FIG. 7, a shadow 50 cast by the light reducing member 18 will extend towards the photodetector 14a, while the photodetector 14b will remain fully illuminated. When the off-axis angle θ reaches a first angle θ₁, the shadow 50 reaches the inner edge of the photodetector 14a. As the off-axis angle θ increases beyond θ₁, an increasing portion of the shadow 50 falls on the photodetector 14a, and the signal produced by the photodetector 14a decreases as compared to the signal from the fully illuminated photodetector 14b. When the off-axis angle θ reaches a second angle θ₂, the entire photodetector 14a will be in shadow and will produce no signal (or only a very small signal indicative of dark current and ambient light). Accordingly, by measuring the signals from the photodetectors 14a and 14b, the direction of the light emitting object can be measured.

By referring to FIG. 7, the following relationships for the first and second angles can be found:

$$tan {θ}_{1} = \frac{L}{H} \\ tan {θ}_{2} = \frac{L + D}{H} , \qquad ( 1 )$$

where tan θ represents the trigonometric tangent of the angle θ.

The angular pointing accuracy of the light source locator 10 can be estimated from FIG. 7 and Eqs. (1). If the light emitting object is located at an off-axis angle θ that is less than or equal to θ₁, both photodetectors 14a and 14b will receive substantially the same light power and will produce substantially the same signal. Accordingly, once the light source locator 10 has determined the position of the object to within a pointing accuracy approximately equal to the angle θ₁, further discrimination of the object's position within this angular range becomes more difficult, because the photodetector signals are substantially equal. Therefore, in embodiments similar to the one shown in FIG. 7, the light source locator 10 has a pointing accuracy approximately equal to the first angle θ₁. This level of pointing accuracy will be referred to as “coarse” pointing accuracy, and embodiments (such as those in FIGS. 1-7) provide a “coarse mode” of pointing and tracking. Various embodiments of the light source locator 10 can be configured to provide a desired level of coarse pointing accuracy by selecting suitable values for L and H, according to Eq. (1).

In certain embodiments, the object to be located is the sun. The sun is not a point source of light, but has an angular size, as seen from the Earth, equal to about 0.5 degrees. In certain preferred embodiments, the light source locator 10 is configured to provide coarse pointing accuracy sufficient to point to the disk of the sun, e.g., the coarse pointing accuracy is about 0.5 degrees. In one such preferred embodiment, the photodetectors 14a, 14b have a size D≈1 cm and are positioned about L≈1 mm from the optical axis 22. Equation (1) indicates that the length of the light reducing members 18 should be about H≈11.5 cm for the light source locator 10 to be able to point to the sun's disk.

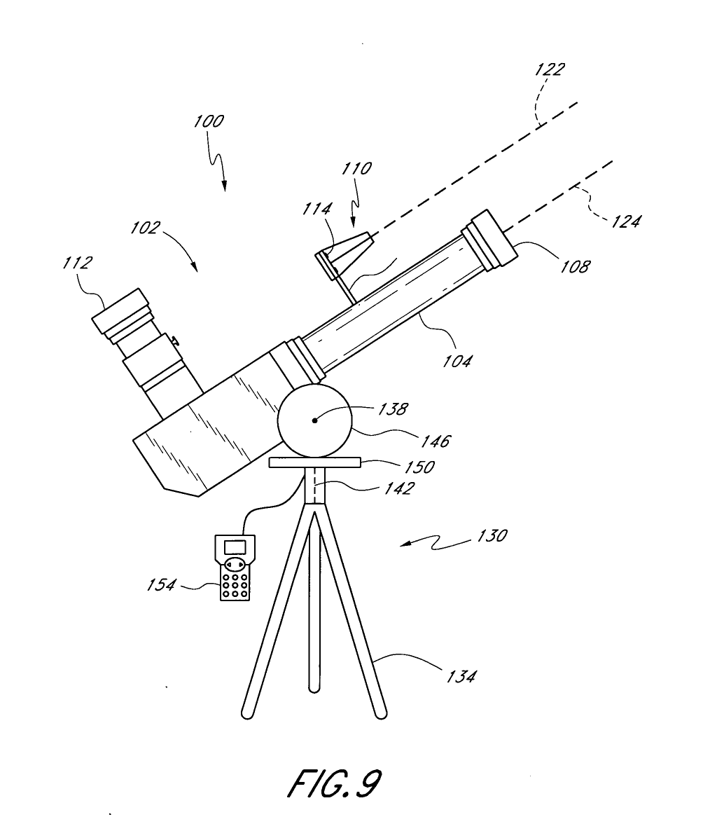

Some embodiments of the light source locator 10 enable location of the light emitting object to within an angular accuracy that is better (e.g., smaller) than the coarse pointing accuracy discussed with reference to FIG. 7. Such embodiments provide “fine” pointing and tracking. FIGS. 8A and 8B are top views of two embodiments of the light source locator 10 that provide fine pointing and tracking. Many of the features of the light source locators 10 illustrated in FIGS. 8A and 8B are substantially similar to those illustrated in FIGS. 1-3. Also, although the embodiments shown in FIGS. 8A and 8B comprise locators 10 having four light reducing members 18 and four photodetectors 14, this is not a limitation, and other embodiments may have fewer or more light reducing members 18 and/or photodetectors 14. Additionally, different embodiments may be configured and arranged differently than shown in FIGS. 8A and 8B without departing from the scope of the principles disclosed herein.

The light source locator 10 illustrated in FIG. 8A comprises a position sensing detector (PSD) 60 that is configured to provide fine pointing and tracking. The PSD 60 is disposed on the base 26. The PSD 60 may be disposed in a position different from that shown in FIG. 8A such as, for example, closer to the optical axis 22, or even centered on the optical axis 22. In other embodiments, the PSD 60 can be disposed on a flange, rim, or edge projecting from a light reducing member 18. In some embodiments, more than one PSD 60 may be used. The PSD 60 may include imaging optics such as, for example, a lens and/or a pinhole, in order to form an image of a light emitting object on a portion of the PSD 60. In some embodiments, one or more light reducing members (e.g., vanes) are disposed on or near the PSD 60 to produce shadowing or to otherwise disrupt light from a light emitting object so as to provide differential light signals to portions of the PSD 60. In one embodiment, an element that at least partially reduces light intensity is disposed above the PSD 60 so as to cast a shadow on a portion of the PSD 60 to further assist fine pointing and tracking.

In some embodiments, the PSD 60 comprises a segmented position sensing detector such as, for example, a quadrant detector. A quadrant detector typically comprises a uniform semiconductor sensor having two mutually orthogonal narrow gaps, which separate the sensor into four independent and equal photodetectors. A light beam directed onto the quadrant detector will produce four photocurrents that are in proportion to the light power falling on each of the four quadrants. The four photocurrents may be combined to determine the location (e.g., an x-y location) of a centroid of the light beam. In other embodiments, the PSD 60 comprises a continuous position sensing detector such as, for example, a lateral effect detector. A lateral effect detector typically comprises a uniform semiconductor substrate, without a gap, and having electrodes at opposite ends of the substrate. A light beam directed onto the lateral effect detector produces photocurrents at the electrodes that are in proportion to the position of the centroid of the light beam along the substrate. Some embodiments of the light source locator 10 use dual-axis lateral effect detectors, which are configured to measure the light beam centroid position along two orthogonal axes.

In other embodiments, the PSD 60 may comprise additional or different optoelectronic devices capable of measuring the position of a light beam. For example, the PSD 60 may comprise a charge coupled device (CCD), a focal plane array (FPA), a Shack-Hartmann sensor, an array of photodiodes or phototransistors, or other suitable photo sensing devices.

FIG. 8B illustrates another embodiment of a light source locator 10 that provides a fine mode of pointing and tracking. The light source locator 10 comprises a fine tracking device 70, which, in some embodiments, comprises a hollow tube disposed substantially along the optical axis 22 of the locator 10. In other embodiments, the tube is displaced away from the optical axis 22 but is oriented substantially parallel to the axis 22. A distal end of the tube is disposed toward the direction of the light emitting object, and a proximal end of the tube is disposed toward the base 26 of the locator 10. The distal end of the tube comprises optics 74 configured to form an image of the object on a sensor disposed at the proximal end of the tube. In some embodiments, the optics 74 comprises a pinhole aperture or a lens. A PSD (not shown in FIG. 8B) is disposed at the proximal end of the tube so as to receive the image from the optics 74. As discussed above with reference to FIG. 8A, the PSD may comprise, for example, a quadrant detector, a lateral-effect detector, a CCD, or any other suitable position sensing optoelectronics device. The signals from the PSD are combined to determine a location of a centroid of the image produced by the optics 74.

In embodiments such as those shown in FIGS. 8A and 8B, the PSD 60 enables fine pointing and location, because the PSD 60 can measure small changes in the centroid position of the light received from the object. For example, if the off-axis angle of the object changes by about 0.1 degrees, the position of the centroid of the image formed on the PSD 60 will change by about 200 microns for a light source locator 10 having a length of about 11.5 cm. This change in beam position is readily detectable with commercially available PSDs, which typically can detect changes in position larger than several microns. Accordingly, very small changes in the off-axis angle of the object can be detected by the PSD 60. Therefore, light source detectors 10 that include a PSD 60 advantageously provide both coarse and fine pointing and tracking.

Other configurations of light source detectors 10 are possible. In some embodiments, more than one PSD may be used to provide more accurate and precise fine pointing and tracking. In other embodiments, one or more of the coarse positioning photodetectors 14 is a PSD (e.g., a quadrant detector). Many variations are possible.

The light source locator 10 may be used to point and track an object by detecting light emitted, transmitted, or reflected from a portion of the object. In certain embodiments, the object (e.g., the sun) produces light with sufficient power to produce measurable photodetector signals. In other embodiments, the object to be located does not produce its own light. Accordingly, the light source locator 10 may include a source of light (e.g., a laser beam) that is used to illuminate an object. The light source locator 10 may then point and track the object by measuring the light reflected from the object.

In some embodiments, the objects that can be located by the light source locator 10 include terrestrial objects or targets. Some embodiments may be configured to locate and track the position of moving objects or to align industrial machinery or structures by locating reference or target light sources. The light source locator 10 can be included as a component in other measuring devices. Many uses are possible.

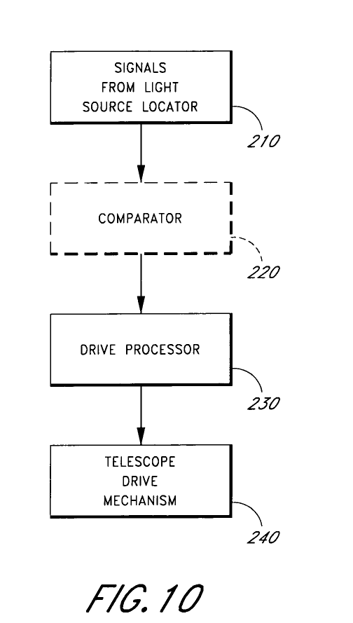

In certain embodiments, the object to be located is a celestial object, and in certain preferred embodiments, the object is the sun or the moon. FIG. 9 is a schematic diagram of a solar observing system 100 comprising a telescope 102, a telescope mount 130, and a light source locator 110. In various embodiments, the telescope 102 may comprise a refracting telescope, a reflecting telescope, or other type of telescope such as, for example, a catadioptric telescope. In some embodiments, the telescope 102 is adapted for use by ordinary consumers including, for example, amateur astronomers, sun gazers, star gazers, and/or hobbyists. The telescope 102 may include components and devices not shown in FIG. 9 such as, for example, a finderscope. The solar observing system 100 may comprise the telescope 102 and/or other light collecting devices such as, for example, binoculars, spotting scopes, mirrors, lenses, solar collectors, solar concentrators, solar cells, heliostats, and/or satellite dishes. In certain preferred embodiments, the solar observing system 100 comprises a ground-based optical system such as, for example, a ground-based telescope. In certain such embodiments, the ground-based telescope is a consumer-oriented telescope. In other embodiments, the light source locator 110 can be used with a space-based optical system.

The telescope 102 shown in FIG. 9 is a refracting telescope that comprises an objective lens 108 configured to receive light from an object and to focus the light onto imaging optics 112. The imaging optics 112 may comprise a user's eye, an eyepiece, or an ocular. Additionally, the imaging optics 112 may comprise one or more optoelectronic devices such as, for example, a digital camera, a CCD detector, a spectrometer, a photometer, or other suitable imaging apparatus. The telescope 102 comprises a telescope housing 104 that includes the objective lens 108 and the imaging optics 112. The housing 104 may include other optical elements such as, for example, mirrors, prisms, lens, and filters. The telescope housing 104 is fabricated from a rigid material such as metal or plastic. In some embodiments, the telescope housing 104 is fabricated from aluminum, for example, milled aluminum. In certain embodiments, the telescope housing 104 is substantially opaque to the light from the object. The inside of the housing 104 may include baffles, stops, and similar structures and may be finished in a matte, black color to minimize internal reflections or ghosts. The telescope 102 comprises an optical axis 124 substantially parallel to the housing 104 and disposed substantially in the center of the objective lens 108.

In certain embodiments for observing the sun, the telescope 102 includes filters designed to block a significant portion of the sun's light in order to prevent damage to a user's eye. For example, the filters may transmit only a narrow band of light from the sun. In some embodiments, the filter bandpass is less than about one Angstrom and may be centered on a spectral line, such as hydrogen-alpha (656.3 nm) or calcium-K (393.4 nm). Suitable telescopes 102 for observing the sun include, for example, a Personal Solar Telescope or a SolarMax Telescope, available from Coronado (Tucson, Ariz.), and suitable solar filters include, for example, a SolarMax hydrogen-alpha or calcium-K filter, also available from Coronado. In other embodiments, the system 100 may comprise another consumer-oriented telescope or consumer-oriented solar telescope.

The solar observing system 100 further comprises the telescope mount 130. The telescope mount 130 may comprise, for example, a tripod, a polar or equatorial mount, or an altitude-azimuth (alt-azimuth) mount. Other types of mounts are possible. The mount 130 comprises a support structure 134 to support the telescope 102. Generally, the mount 130 is configured to permit the telescope 102 to point to a target location. In various embodiments, the mount 130 is used to support the telescope 102 at a terrestrial observing site such as, for example, a yard, a field, or other suitable outdoor space. However, the mount 130 can also be disposed on or in, for example, a balcony, a patio, a roof, a room, or any other suitable location that permits a view of terrestrial or celestial objects. In some embodiments, the mount 130 is disposed in a suitable structure such as, for example, an observing dome. The mount 130, in some embodiments, is portable such that a user can transport the solar observing system 100 from place-to-place, e.g., from a location where the system 100 is stored to a location where the user desires to perform observations. In other embodiments, the mount 130 may be a substantially permanent mount, e.g., a pedestal or pier substantially attached to or embedded in the ground at the observing site. In the embodiment shown in FIG. 9, the support structure 134 comprises three tripod legs; however, in other embodiments, the support structure 134 may comprise a pedestal or a pier. The mount 130 shown in FIG. 9 is an alt-azimuth mount that permits the telescope 102 to move around two orthogonal axes: an altitude axis 138 and an azimuth axis 142. Movement in altitude permits the telescope 102 to move in a vertical plane from the horizon (at zero degrees altitude) to the zenith (at ninety degrees altitude). Movement in azimuth permits the telescope 102 to move in a horizontal plane from North (0 degrees azimuth), East (90 degrees azimuth), South (180 degrees), and West (270 degrees).

An altitude drive mechanism 146 may be used to automatically move the telescope 102 about the altitude axis 138. Similarly, an azimuth drive mechanism 150 may be used to automatically move the telescope 102 about the azimuth axis 142. The drive mechanisms 146 and 150 comprise drive motors mechanically coupled to drive gears configured to rotate the telescope 102 about the axes 138 and 142, respectively. In some embodiments, the drive motors are stepper motors or servo-motors, and the drive gears are worm gears. The drive motors may be electrically coupled to a drive processor 154 that controls drive rates at which the telescope 102 rotates around each of the axes 138 and 142. For example, the drive rates may be selected to enable sidereal tracking of stars or to enable solar tracking of the sun or lunar tracking of the moon. The drive processor 154 is configured to communicate drive signals to the drive mechanisms 146 and 150 so as to control the pointing, tracking, and guiding of the telescope 102. For example, some embodiments of the drive mechanisms 146 and 150 include position sensing devices such as, for example, rotary encoders for sensing the angular position of the axes 138 and 142. The rotary encoders may comprise mechanical, optical, or magnetic encoders. The drive processor 154 may communicate drive signals through an electric connection such as a wire or may use wireless signals such as, for example, infrared or radio frequency signals. In some embodiments, the drive processor 154 comprises an Autostar Computer Controller (Meade Instruments Corp., Irvine, Calif.).

Embodiments of the drive processor 154 include electronic circuitry to control the drive mechanisms 146 and 150 according to the commands of a user. The drive processor 154 may include a set of logic instructions for converting user commands into electronic drive signals. For example, in some embodiments, the drive processor 154 implements software instructions such as Autostar Suite™ and/or AutoAlign™ (Meade Instruments Corp., Irvine, Calif.).

The drive processor 154 may include additional circuitry to implement or automate additional features and processes. For example, the drive processor 154 may control or monitor the operation of the imaging optics 112, such as the focus or exposure time of a digital camera or a CCD. The drive processor 154 may control and monitor the position of the telescope 102 about each of the axes 138 and 142 in order to prevent the telescope 102 from moving beyond suitable operating ranges. The drive processor 154 may receive feedback from, for example, the drive motors or the rotary encoders, so as to more accurately control the position, orientation, and tracking of the telescope 102. Other functions and processes can be controlled or monitored by the drive processor 154. In certain preferred embodiments, the solar observing system 100 is adapted so that it is easy and convenient to use by ordinary consumers.

The solar observing system 100 includes the light source locator 110, which may comprise, for example, any of the embodiments shown in FIGS. 1-8B. The light source locator 110 shown in FIG. 9 is generally similar to the light source locator 10 illustrated in FIGS. 1-3. The light source locator 110 comprises photodetectors 114 for locating the sun, and additionally, may comprise a position sensing detector (such as the PSD 60 shown in FIGS. 8A and 8B) to enable fine scale pointing and tracking. The light source locator 110 is attached to the telescope 102 by a mounting device 111. The mounting device 111 may include positioning elements such as, for example, set screws, that can be used to adjust the orientation of the light source locator 110. An optical axis 122 is centrally located through the light source locator 110. The optical axis 122 of the light source locator 110 may be aligned to be substantially parallel to the optical axis 124 of the telescope by, for example, adjusting the positioning elements on the mounting device 111. Accordingly, when the light source locator 110 is pointed toward a distant object, the telescope 102 will also be pointed toward the object.

The light source locator 110 is configured to communicate signals from the photodetectors 114 (and/or a fine position sensing detector) to the drive processor 154, the drive mechanisms 146 and 150, and/or other components of the solar observing system 100. The light source locator 110 may communicate the signals by an electrical connection such as, for example, a wire, or by wireless methods, including infrared or radio frequency signals. In some embodiments, the light source locator 110 is configured to communicate with the imaging optics 112, by wired and/or wireless methods. For example, in certain embodiments, information communicated from the light source locator 110 may be used to enable precise pointing and/or focusing of an image onto the imaging optics 112 so as to enable automated image acquisition, e.g., solar photography.

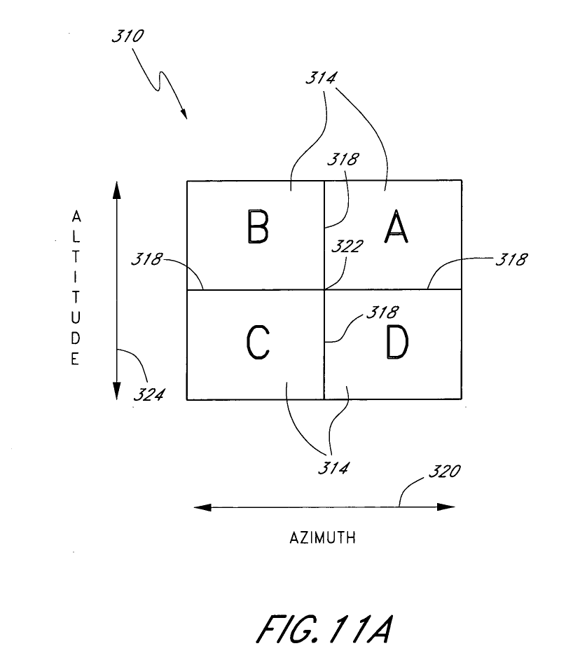

FIG. 10 is a flowchart illustrating an embodiment of a method that can be used by the solar observing system 100 to locate and track the sun. In Block 210, a light source locator receives light from an object. The light source locator comprises photodetectors that detect that light and produce one or more signals in response to the received light. For example, the light source detector 10 illustrated in FIGS. 1-3 produces four signals. Other light source detectors may produce fewer or more signals. Light source detectors (such as those illustrated in FIGS. 8A and 8B) may produce signals for coarse positioning, fine positioning, and/or both coarse and fine positioning.

In Block 220, the signals may be communicated to an (optional) comparator by wired and/or wireless techniques. The wireless techniques may include transmitting and/or receiving electromagnetic signals, such as, for example, infrared or radio frequency signals. In some embodiments, the comparator comprises a microprocessor that implements a set of logic instructions for processing and/or analyzing the signals from the light source locator. The logic instructions used by the comparator may be encoded in hardware, firmware, or software. The logic instructions may implement algorithms that use information from the signals to estimate parameters relating to the object. For example, the parameters may include one or more of a position, a location, a direction, a speed, a velocity, a size, a brightness, a flux, a fluence, a power, an intensity, or other aspect relating to the object.

In FIG. 10, Block 220 is illustrated in phantom lines, because a comparator is an optional element in a light source location and tracking system. For example, in certain embodiments, some or all of the functions of a comparator are performed by other components in the system, e.g., by a drive processor, a central processing unit, a controller, or other suitable hardware, software, or firmware. In other embodiments, some or all of the functions of the comparator are performed remotely from the system 100, e.g., by a remote computer. In various embodiments that include a comparator, the comparator may be disposed within the light source locator, a drive processor, one or more drive mechanisms, drive motors, or in other components of the solar observing system 100. In other embodiments, the comparator may be remote from the system 100 such as, for example, by being located on a computer network.

In optional Block 220, the comparator produces one or more signals indicative of the parameters relating to the object. For example, the comparator signals may indicate one or more angular directions to the object. In Block 230, the comparator signals are communicated to a drive processor such as, for example, the drive processor 154. The drive processor may also receive signals from one or more drive mechanisms that are used to move the telescope about one or more axes. For example, one or more encoders coupled to the telescope axes may communicate the angular position of the telescope axes to the drive processor. The drive processor may further process or analyze the signals received from different components in the solar observing system 100. The drive processor may be separate from or integrated with the comparator, and either or both may be implemented in hardware, software, or firmware. In certain embodiments, the drive processor is disposed in or on the telescope. In other embodiments, the drive processor is disposed within a portable unit such as, for example, a laptop computer or handheld device. In certain preferred embodiments, the drive processor and the comparator are disposed within the handheld device, which may be configured similarly to an Autostar Computer Controller (Meade Instruments Corp., Irvine, Calif.).

In Block 240, the drive processor communicates with the telescope drive mechanisms so as to move the telescope as needed. In some embodiments, the drive processor generates one or more signals that are communicated to drive motors coupled to the axes of the telescope. The drive processor can communicate signals so as to cause the telescope to point toward the object and/or to track the object as it moves. For example, the drive processor may communicate signals to the telescope drive mechanism to move the telescope at the solar or sidereal rate.

In some embodiments, the drive processor and the telescope drive mechanism may be capable of moving the telescope in several drive modes. For example, in a pointing mode, the drive processor may signal the telescope drive mechanism to move the telescope at a fast slew rate so as to rapidly locate and point to the object. In a tracking mode, the drive processor may signal the telescope drive mechanism to move the telescope at a guide rate so as to keep the object located within a field of view of the telescope. In a centering mode, the drive processor may signal the telescope drive mechanism to move the telescope at an intermediate slew rate so as to quickly center the object within a field of view of an eyepiece or a camera. In various embodiments, the fast slew rate may range from about 1 degree per second to about 10 degrees per second; the intermediate slew rate may be at 16× or 64× the sidereal rate; and the guide rate may be the solar, sidereal, or lunar rate. Certain embodiments may implement additional slew rates for the convenience of the user. Other embodiments of the system 100 may implement additional and/or different pointing and tracking modes and rates. Further, the pointing and tracking modes may be implemented differently in two-axis (e.g., alt-azimuth) or single-axis (e.g., polar or equatorial) telescope mounts.

The flowchart illustrated in FIG. 10 is intended to be illustrative of one method for locating and tracking an object and is not intended to be limiting. In other embodiments of locating and tracking methods, additional or fewer steps may be used, and the order in which the steps are performed may be different. The components shown in Blocks 210-240 may be configured or arranged differently, and the components may implement additional, fewer, or different functions, methods, and processes. As discussed herein, Block 220 is optional, and the functions of the comparator may be carried out by other components in the system. Other embodiments may combine the functions of the blocks in FIG. 10 and/or include additional or different blocks. Further, methods similar to the embodiment shown in FIG. 10 may be developed to locate and track objects other than a celestial object such as the sun.

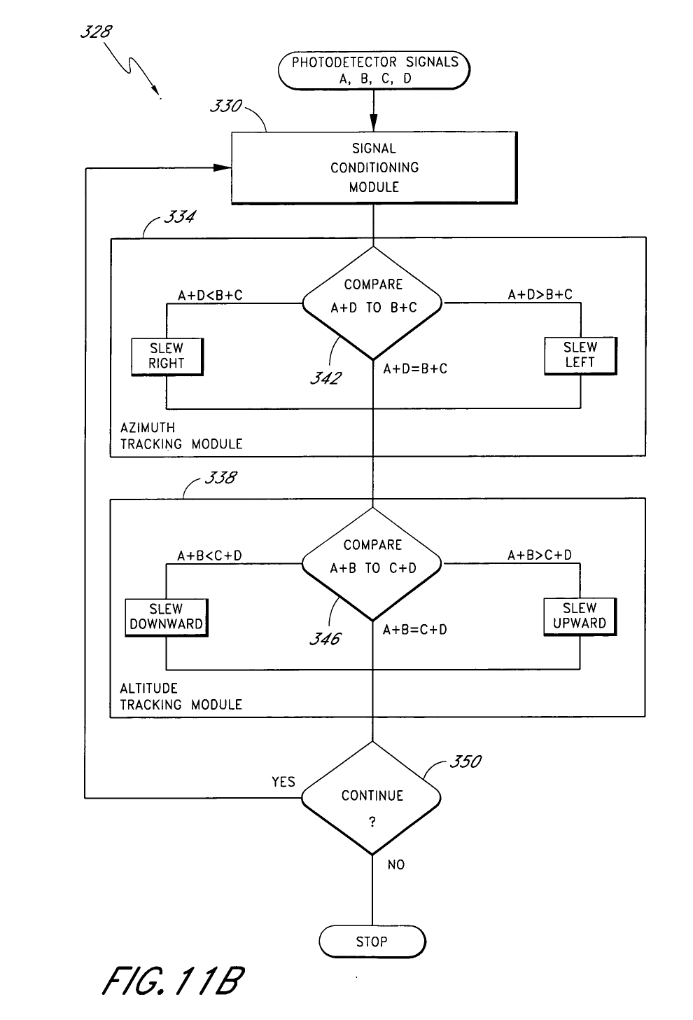

FIG. 11A is a schematic top view diagram of an arrangement of photodetectors 314 in a light source locator 310 mounted on an alt-azimuth telescope (not shown). The photodetectors 314 may be used to locate, point to, and track an object. In this embodiment, four photodetectors 314 are used, and this number is intended to be illustrative and not to be limiting. Each of the four photodetectors 314 produces signals (e.g., photocurrents) in response to incident light, and the four signals are denoted as A, B, C, and D. In many embodiments, the photodetector signals are analog signals (e.g., photocurrents or photovoltages); however, in some embodiments, the photodetector signals are digital signals or a combination of analog and digital signals. The four photodetectors 314 are arranged in a plane that is substantially perpendicular to an optical axis 322 of the light source locator 310. The light source locator 310 comprises four light reducing members 318 that are substantially opaque to the light from the object. Depending on the location of the object, the light reducing members 318 will cast shadows on the photodetectors 314, which will produce signals A, B, C, and D that can be used to estimate the location of the object.

As shown in FIG. 11A, motion of the telescope in azimuth is marked by arrow 320, and motion of the telescope in altitude is marked by arrow 324. In some embodiments, the signals A, B, C, and D from the photodetectors 314 are communicated to a comparator, as further described with reference to Block 220 of FIG. 10. The comparator is configured to use the photodetector signals to estimate a location of the object. As described herein with reference to Blocks 230 and 240 of FIG. 10, the comparator can communicate information relating to the object's position to a drive processor and/or telescope drive mechanisms to move the telescope in azimuth and/or altitude in order to point to and/or track the object. In other embodiments, the functions carried out by the (optional) comparator can be performed by other components of the system, e.g., a drive processor.

FIG. 11B illustrates an embodiment of a flowchart describing a sample process 328 by which the photodetector signals A, B, C, and D can be used to locate and track the object. The process 328 comprises a signal conditioning module 330, an azimuth tracking module 334, and an altitude tracking module 338. In other embodiments, the process 328 may comprise more or fewer modules, which may be arranged and interconnected differently. The functions and procedures performed by the modules may be different, and the modules may implement different algorithms and procedures. In an embodiment, the process shown in the process 328 is implemented by a comparator such as that described in optional Block 220 in FIG. 10. In other embodiments, some or all of the functions and modules illustrated in the process 328 may be carried out by different components of the system such as, for example, the drive processor or the telescope drive mechanisms. Many variations are possible, and FIG. 11B is intended as an illustrative, non-limiting embodiment of a process for locating and tracking an object.

As used herein, the word module refers to logic embodied in hardware or firmware, or to a collection of software instructions, possibly having entry and exit points, written in a programming language, such as, for example, C, C++, Fortran, or Pascal. A software module may be compiled and linked into an executable program, installed in a dynamic link library, or may be written in an interpreted programming language such as BASIC, Perl, Java, or Python. Some portions of the logic may be performed by a symbolic computational or graphical program such as, for example, Mathematica®, Maple®, or MATLAB®. It will be appreciated that software modules may be callable from other modules or from themselves, and/or may be invoked in response to detected events or interrupts. Software instructions may be embedded in firmware, such as an erasable programmable read-only memory (EPROM). It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

As shown in FIG. 11B, the signal conditioning module 330 receives the signals A, B, C, D from the photodetectors 314. The signal conditioning module 330 may condition the signals by, for example, filtering, amplifying, multiplexing, and/or digitizing. The signal conditioning module 330 may include timing, clocking, synchronization, and noise reduction circuitry. Additionally, the signals A, B, C, D may be converted from one electrical form to another, for example, a photocurrent may be converted to a photovoltage. In certain preferred embodiments, the signals A, B, C, and D are photocurrents that are amplified to enable more precise measurements. Some embodiments may utilize one or more high gain transimpedance amplifiers (TIA) to convert the photocurrents into measurable difference voltages. For example, certain embodiments transmit the photocurrents A, B, C, and D to a MAX3825 Quad Transimpedance amplifier (Maxim Integrated Products, Sunnyvale, Calif.), which produces measurable output voltages at a transimpedance gain of 3.7 kOhm.

The conditioned signals are communicated to the azimuth tracking module 334 and the altitude tracking module 338, which are configured to communicate output signals to the drive processor and/or the drive mechanisms to move the telescope. For example, the output signals may include instructions to move the telescope about a particular axis, in a particular direction, and at a particular rate. As described herein, azimuth directions such as “right” or “left,” and altitude directions such as “upward,” “above,” “downward,” or “below” are measured with respect to the plane of the photodetectors 314 looking outward along the optical axis 322 toward the object (see FIG. 11A).

FIG. 11B illustrates embodiments of algorithms that may be implemented by the azimuth and altitude tracking modules 334 and 338. In Block 342 of the azimuth tracking module 334, the sum of signals A and D are compared to the sum of the signals B and C. If the sum of signals A and D is greater than the sum of signals B and C, the object is to the left of the optical axis 322, and the azimuth tracking module 334 transmits an instruction to slew the telescope to the left. Conversely, if the sum of signals A and D is less than the sum of signals B and C, the object is to the right of the optical axis 322, and the azimuth tracking module 334 transmits an instruction to slew the telescope to the right. If the sum of signals A and D equals (to within a tolerance) the sum of signals B and C, no action is taken.

In Block 346 of the altitude tracking module 338, the sum of signals A and B are compared to the sum of the signals C and D. If the sum of signals A and B is greater than the sum of signals C and D, the object is above the optical axis 322, and the altitude tracking module 338 transmits an instruction to slew the telescope upward. Conversely, if the sum of signals A and B is less than the sum of signals C and D, the object is below the optical axis 322, and the altitude tracking module 338 transmits, an instruction to slew the telescope downward. If the sum of signals A and B equals (to within a tolerance) the sum of signals C and D, no action is taken.

In Block 350, an inquiry is made whether to continue to move the telescope. If the answer is yes, the process 328 loops back to the signal conditioning module 330 to receive further inputs from the photodetectors, and if the answer is no, the process 328 stops. In some embodiments, the process 328 may include modules configured to display information related to the inquiry on a screen, monitor, or other display, and which may be conveyed to a user audibly, tactilely, or visually. The user may input an answer to the inquiry via a keyboard, keypad, buttons, switches, or sensors. For example, the user may input a “stop” answer when the object is located within the field of view of the telescope.

In other embodiments, the process 328 utilizes a feedback loop to automate pointing the telescope toward the object. For example, in certain embodiments, the process 328 may repeat the procedures implemented in the modules 330, 334, and 338 until each of the signals A, B, C, and D is substantially equal to within an error tolerance. When the four signals are substantially equal, the object has been located to within the error tolerance, and the telescope has been accurately pointed toward the object.

After the telescope is pointed toward the object, the system 100 may continue to monitor the photodetector signals in order to track the motion of the object. For example, if the object moves away from the direction of the optical axis 322 of the light source locator 310, the signals A, B, C, and D will depart from substantial equality. The system will then transmit signals to the azimuth and/or altitude drive mechanisms to re-center the object. For example, in certain embodiments, the system 100 implements a process similar to the process 328 to track the object.

In other embodiments of the location and tracking process, the system 100 may utilize algorithms, procedures, and modules that are additional to and/or different from those illustrated in FIG. 11B. For example, in some embodiments the signals A, B, C, and D are combined to produce a coordinate location of the object. In one such embodiment, Cartesian x-y coordinates are determined from the photodetector signals according to:

$$x = \frac{( A + D ) - ( B + C )}{A + B + C + D} \\ y = \frac{( A + B ) - ( C + D )}{A + B + C + D} . \qquad ( 2 )$$

In this embodiment of a location process, the system 100 transmits instructions to the drive processor or the drive mechanisms so as to reduce the coordinate values in Eq. (2) zero (to within an error tolerance). The object is located when the x-y coordinates are substantially equal to zero. Such an algorithm may be readily implemented in a feedback loop that monitors the x-y coordinates and makes adjustments to the altitude and azimuth drive mechanisms to ensure the x-y coordinates remain substantially equal to zero.

In other embodiments, the process 328 may include additional or different hardware or software modules than shown in the sample flowchart shown in FIG. 11B. The system 100 may include other electronic circuits to implement other modules. For example, in some embodiments the system 100 uses a bridge circuit (such as a Wheatstone bridge) to determine when the four signals A, B, C, and D are substantially equal. Many variations in logic and circuitry are possible.

The embodiment of the process 328 schematically shown in FIG. 11B may be used with the signals from coarse positioning photodetectors (such as, for example, the photodetectors 14 in FIGS. 1-3) and/or the signals from the fine positioning photodetectors (such as, for example, the PSD 60 in FIGS. 8A and 8B). In some embodiments, the process 328 uses the coarse positioning signals until the object is located to within the angular accuracy given by, for example, Eq. (1), and then the process 328 switches to the fine positioning signals from a position sensing detector to further locate or track the object. In such embodiments, the light source locator advantageously can use the large field of view of the coarse positioning photodetectors to slew rapidly to the vicinity of the object and then switch to the narrow field of view of the fine positioning photodetectors to accurately and precisely center the telescope on the object.

As further discussed herein with reference to Block 240 of FIG. 10, the system 100 may be configured to implement several different drive modes such as, for example, a pointing mode, a tracking mode, and a centering mode. In the pointing mode, the system 100 may signal the drive processor and/or the drive mechanisms to move the telescope at a fast slew rate in order to initially point the telescope toward the object. In the tracking or centering modes, the system 100 may periodically, intermittently, or in response to a user command, signal the drive processor and/or the drive mechanisms to make small adjustments to the position of the telescope. The logic and/or circuitry used to enable the various drive modes may be implemented by a drive processor, such as the drive processor 154, or by other system components such as the drive mechanisms (e.g., drives 146 and 150), or by an optional comparator, or by other suitable hardware or software in communication with the system 100.

In some embodiments, a light source locator may be used to track individual features on the sun such as, for example, sunspots, flares, or prominences. Sunspots are regions of the sun having high concentrations of magnetic field and which are cooler, and therefore darker, than surrounding portions of the sun. In certain embodiments, the light source locator can track a sunspot by producing a negative image of the sun in which the sunspot appears to be light and the surrounding solar portions appear to be dark. Methods similar to those discussed with reference to FIGS. 11A and 11B can be used to locate and track the sunspot position within the negative solar image.

In other embodiments, some or all of the functions and processes carried out by the modules 330, 334, and 338 of the process 328 are performed by electronic circuitry in the drive processor, or by electronic circuits located elsewhere in the system, for example, in the telescope axis drive mechanisms, in other components of the telescope, or remotely on a network. Many variations of electronic circuitry, processors, hardware, software, and firmware are possible without departing from the principles disclosed herein.

The modules and functions of the process 328 may be implemented in electronic circuitry comprising hardware, firmware, and/or software. The set of logic instructions implemented by the electronic circuitry may be embodied by a computer program that is executed by a processor or electronics as a series of computer- or control element-executable instructions. These instructions or data usable to generate these instructions may reside, for example, in random access memory (RAM), on a hard drive or optical drive, or on a disc. Alternatively, the instructions may be stored on magnetic media, electronic read-only memory, or other appropriate data storage device or computer accessible medium that may or may not be dynamically changed or updated.

The solar observing system 100 may include a user interface, which enables the user to input commands and to receive output information. In some embodiments, the user interface may comprise, for example, a computer, laptop, palm top, personal digital assistant, cell phone, or the like. Information may be displayed on a screen, monitor, or other display, and/or conveyed to the user via sound or touch, as well as by sight. A keyboard or keypad, or one or more buttons, switches, and sensors can be used to input information such as, for example, commands, data, specification, settings, etc. A mouse, joystick, or other interfaces can be used as well. User interfaces both well known in the art, as well as those yet to be devised may be employed to input and output information and commands. In certain embodiments, the user interface comprises the drive processor 154 and is optionally and additionally used for input/output operations via, for example, a keypad, a mouse, a joystick, a touchscreen, or other suitable input/output device. The user interface may include operating functionality similar to software programs such as, for example, Autostar Suite™ and/or AutoAlign™ (Meade Instruments Corp., Irvine, Calif.). It is preferable, although not necessary, for the user interface to provide easy and convenient use of the system 100 by ordinary consumers.

Some or all of the telescope pointing and tracking electronics may be included in a processor such as, for example, the drive processor 154 or an optional comparator (e.g., as described with reference to Block 220 of FIG. 10). For example, in the case where the user interface comprises a computer, laptop, palm top, personal digital assistant, cell phone, or the like, both the user interface as well as some or all of the control and processing electronics may be included in the computer, laptop, palm top, personal digital assistant, cell phone, etc. Additionally, some or all the processing can be performed all on the same device, on one or more other devices that communicates with the device, or various other combinations. The functions of the drive processor or comparator may also be incorporated in a network and portions of the process may be performed by separate devices in the network. Processing electronics can be included elsewhere on or external to the telescope and may be included for example in the drive mechanisms 146 and 150, as well as in or on the housing 104 or elsewhere. The control electronics may be in the form of processors, chips, circuitry, or other components or devices and may comprise non-electronic components as well. Other types of processing, electronic, optical, or other, can be employed using technology well known in the art as well as technology yet to be developed.

Embodiments of the solar observing system 100 can utilize any of the disclosed methods for locating and tracking an object (e.g., the methods of FIG. 10 or 11B) with other observing methods or procedures to beneficially provide additional functionality to the system 100. For example, some embodiments of the solar observing system 100 are configured to provide an estimated position for the sun (e.g., an estimated altitude and azimuth) from the user's geographic position (e.g., latitude and longitude) and the date and time. Many algorithms for estimating the position of the sun are known in the art. In some embodiments, the estimation is performed by a processor configured to communicate with the solar observing system 100. For example, in some embodiments, the drive processor 154 performs the calculations to estimate the sun's position. The drive processor 154 may include a clock or other suitable timing circuitry to provide the date and time used in the estimation process. In some embodiments, the solar observing system 100 can be directed (e.g., by a user or a processor) to point the telescope 102 and the light source locator 110 toward the estimated solar position. For example, the drive processor 154 can issue commands to the drive mechanisms 146 and 150 to move the telescope 102 to the estimated altitude and azimuth. In certain embodiments, the user can direct the telescope 102 to point to the estimated solar position by entering a suitable command through a user interface (e.g., a keypad). In other embodiments, the estimated solar position is used as a “home position” toward which the telescope 102 points at, for example, system startup. In some embodiments, after the telescope 102 is pointed towards the estimated solar position, the light source locator 110 is used to provide additional coarse and/or fine guidance to more accurately point the telescope 102 to the actual position of the sun.

Embodiments of the solar observing system 100 that enable the telescope 102 to be pointed toward the estimated solar position provide at least several benefits. For example, the sun may be blocked or obscured by, e.g., clouds or nearby buildings or structures, which may temporarily reduce the ability of the light source locator 110 to locate the sun. In such cases it may be advantageous to point the telescope 102 toward the estimated solar position and then use the altitude and azimuth drive mechanisms 146 and 150 track the sun's diurnal motion until the sun is no longer blocked or obscured. At such time, the light source locator 110 can be used to more accurately point the telescope 102 to the sun's actual position. A further benefit is provided by embodiments of the system 100 that are configured to perform a comparison between the estimated solar position and the more accurate position provided by the light source locator 110. The estimated solar position can depart from the actual solar position due to, for example, drift or other errors in the clock that is used to provide the time to the processor performing the estimative algorithm. By comparing the estimated solar position to the actual solar position provided by the light source locator 110, the clock's time can be corrected and updated so as to reduce timing drift and other timing errors.

Embodiments of the light source locator and embodiments of any of the methods disclosed herein may be used with other light detection and/or collection apparatus such as, for example, binoculars, spotting scopes, mirrors, lenses, solar collectors, solar cells, solar concentrators, solar lighting systems, solar water heating systems, heliostats, and/or satellite dishes. The light source locator may be used to detect objects that emit, reflect, or transmit ultraviolet, visible, infrared, microwave, and radio frequencies. Additionally, the light source locator may be used to find the position of objects other than celestial objects. For example, in certain embodiments, a light source, such as a laser, is positioned on a target to be tracked, and a light source locator is configured to locate the position of the laser. The laser may be attached to portions of industrial machinery in which precise alignment is needed. Many other variations are possible.

Additionally, embodiments of the apparatus and methods disclosed herein can be configured to detect and locate a source of acoustic waves. In such embodiments, the apparatus comprises transducers responsive to pressure variations (e.g., microphones) that are used to detect acoustic energy (e.g., sound waves) emitted by an object. Sound reducing members such as, for example, baffles, may be used to shadow or mask the acoustic energy emitted by an object. Differences in the acoustic energy received by the transducers may be used to determine a direction or a position of the object. Methods analogous to those for locating light are used to locate the source of the sound.

While certain preferred embodiments of the invention have been described, these embodiments have been presented by way of example only, and are not intended to limit the scope of the present invention. Various modifications and applications may occur to those skilled in the art without departing from the true spirit and scope of the invention as defined in the appended claims.

What is claimed is:

1. A sunfinder capable of providing an electronic indication of sun location, the sunfinder comprising:
a plurality of photodetectors, each capable of determining at least a presence of illumination;
a plurality of light reduction members; and
a processing device responsive to the plurality of photodetectors to determine at least an indication of a direction of sun location relative to a field of view of the sunfinder.

2. The sunfinder of claim 1, wherein the photodetectors comprise semiconductor photodiodes.

3. The sunfinder of claim 1, wherein the plurality of photodetectors determine the presence or absence of light received from the sun.

4. The sunfinder of claim 1, wherein the plurality of photodetectors measure the light power received from the sun.

5. The sunfinder of claim 1, wherein the light reduction members comprise shadow casting elements.

6. The sunfinder of claim 3, wherein the shadow casting elements comprise three or more fins.

7. The sunfinder of claim 6, wherein the shadow casting elements comprise four substantially orthogonal fins.

8. The sunfinder of claim 1, wherein the light reduction members comprise optical filters.

9. A method of automatically directing a device toward a light source, the method comprising:
receiving light from a light source on at least one surface, the at least one surface comprising a plurality of shadow casting elements, the light incident on the at least one surface at an angle; and
automatically determining a direction of movement of the surface that changes the angle in a manner that moves a device closer to a desired orientation with respect to a location of the light source.

10. The method of claim 9, wherein the light source comprises the sun.

11. The method of claim 9, wherein the device comprises a telescope.

12. The method of claim 11, wherein the telescope comprises a ground-based telescope.

13. The method of claim 12, wherein the ground-based telescope comprises a consumer-oriented telescope.

14. The method of claim 9, wherein the device comprises a solar collector or a solar concentrator.

15. The method of claim 9, further comprising outputting a signal indicative of the direction.

16. The method of claim 9, further comprising outputting commands to an electronic positioning system to cause the device to change its orientation with respect to the location of the light source.

17. The method of claim 9, further comprising moving the device until reaching the desired orientation.

18. A light source locator adapted to electronically determine a position of a light source relative to a position of the locator, the light source locator comprising:
a plurality of light altering elements; and
at least three light sensing elements responsive to light altered by one or more of the plurality of light altering elements.

19. The light source locator of claim 18, wherein the light altering elements comprise fins.

20. The light source locator of claim 19, wherein the fins are substantially opaque to the light.

21. The light source locator of claim 19, wherein the fins are disposed substantially symmetrically about an axis of the light source locator.

22. The light source locator of claim 19, comprising four substantially orthogonal fins.

23. The light source locator of claim 18, wherein at least one of the light sensing elements is disposed in a region between adjacent light altering elements.

24. The light source locator of claim 18, wherein the light sensing elements determine at least a presence or absence of light.

25. The light source locator of claim 18, wherein the light sensing elements measure a power of the light altered by one or more of the plurality of light altering elements.

26. The light source locator of claim 18, wherein the light source is the sun.

27. The light source locator of claim 18 further configured to output at least one signal indicative of a direction of a light source.

28. The light source locator of claim 27, wherein the light source locator is adapted to orient an optical system toward the light source.

29. The light source locator of claim 28, wherein the optical system comprises a telescope.

30. The light source locator of claim 29, wherein the telescope comprises a ground-based telescope.

31. The light source locator of claim 30, wherein the ground-based telescope comprises a consumer-oriented telescope.

32. The light source locator of claim 28, wherein the optical system comprises a solar collector or a solar concentrator.

33. The light source locator of claim 28, wherein the light source is the sun.

34. The light source locator of claim 27, wherein the signal is adapted to be received and processed by a processor capable of determining the direction of the light source.

35. The light source locator of claim 27, wherein the direction of the light source is relative to an optical axis of the light source locator.

36. The light source locator of claim 27 further comprising a processor that determines the direction of the light source.

37. The light source locator of claim 36, wherein the processor is configured to use geographic data and timing data to determine an estimated position of the light source.

38. The light source locator of claim 37, wherein the processor is configured to perform a comparison of the estimated position of the light source and the direction of the light source.

39. The light source locator of claim 38, wherein the processor is further configured to use the comparison to update a system component.

40. The light source locator of claim 39, wherein the system component comprises a timing device.
